(19) United States
(12) Patent Application Publication
(10) Pub. No.: US 2005/0042437 A1
(43) Pub. Date: Feb. 24, 2005

(54) Sound dampening foam

(75) Inventors: N. S. Ramesh, Grapevine, TX (US); Michael D. Grah, Simpsonville, SC (US)

Correspondence Address: Sealed Air Corporation, P.O. Box 464, Duncan, SC, 29334, US

(73) Assignee: Cryovac, Inc.

(21) Appl. No.: 10/643,452

(22) Filed: Aug. 19, 2003

(51) Int. Cl. B32B 3/26; B32B 3/00; B32B 5/22

(52) U.S. Cl. 428/304.4; 428/314.4; 428/317.9; 428/315.7

(57) ABSTRACT

A closed-cell foam comprises at least about 50 weight percent thermoplastic polymer and from about 5 to about 50 weight parts of particles dispersed in the thermoplastic polymer per 100 weight parts of the thermoplastic polymer. The particles have an average size in the longest dimension of from about 5 to about 300 microns. If the particles are electrically conductive, then the foam has a surface resistivity of at least about 1×10⁶ ohms. The foam is useful in sound dampening applications.

### BACKGROUND OF THE INVENTION

The present invention relates to a foam useful for sound dampening, and more particularly to a foamed thermoplastic incorporating particles.

Sound dampening or acoustic attenuation materials are used to reduce unwanted sound transmission through an article or space. Generally, it is recognized that sound transmission loss increases with an increase in the mass per unit area of a sound dampening material. However, in many applications, it is desirable to lower the increase in weight that results from incorporating a sound dampening material in an article. Further, it would be desirable to achieve good sound dampening (i.e., increased sound transmission loss) at a range of lower frequencies, such as less than 1000 Hz, where sound attenuation is more difficult.

### SUMMARY OF THE INVENTION

The present invention addresses one or more of the aforementioned problems. A closed-cell foam comprises at least about 50 weight percent thermoplastic polymer. From about 5 to about 50 weight parts of particles are dispersed in the thermoplastic polymer per 100 weight parts of the thermoplastic polymer. The particles have an average size in the longest dimension of from about 5 to about 300 microns. If the particles are electrically conductive, then the foam has a surface resistivity of at least about 1×10⁶ ohms.

The foam may provide good sound dampening at lower area density than comparable materials. Further, the foam may provide good sound dampening at a range of frequencies below 1000 Hz.

These and other objects, advantages, and features of the invention will be more readily understood and appreciated by reference to the detailed description of the invention.

### DETAILED DESCRIPTION OF THE INVENTION

The sound dampening foam comprises particles dispersed in thermoplastic polymer.

### Foam

The foam may be a closed cell foam. The term “closed cell” foam as used herein means that the foam comprises an open cell content of 30 volume % or less, measured according to ASTM D2856-94 (Procedure A). (For foam having a thickness of less than 0.984 inches, then the foam sample size shall be 0.984 inches by 0.984 inches by the actual average thickness of the foam.) Further, the closed cell foam may comprise no more than about any of the following amounts of open cell volume %: 20%, 10%, 5%, 1%, and 0%. Also, the cells of the closed cell foam may consist essentially of closed cells, or may consist of closed cells.

Alternatively, the foam may be an open cell foam. The term “open cell” foam as used herein means that the foam comprises an open cell content of greater than 30 volume %, measured according to ASTM D2856 as set forth above. The open cell foam may include an open cell content of greater than about any of the following: 40, 50, 60, and 90 volume %. The open cell content may be 100 volume %, or less than about any of the following: 95, 90, 85, and 80 volume %.

The foam may have an average cell size of at least about any of the following values: 0.01, 0.05, 0.1, 0.5, and 1 mm. The foam may have an average cell size of at most about any of the following values: 10, 5, 3, 1, and 0.5 mm. The average cell size may be measured according to ASTM D3576-98 (Procedure A).

The foam may have a configuration, for example, of any of a sheet, plank, slab, block, board, and molded shape.

The average thickness of the foam may be at least about any of the following: 1, 5, 10, 15, 20, 25, 30, 35, 40, 45, 50, 55, 60, 65, 70, 75, 80, 85, 90, 95, and 100 mils. Further, the average thickness of the foam may be at least about any of the following: 0.2, 0.25, 0.3, 0.35, 0.4, 0.5, 0.75, and 1 inches. The average thickness of the foam may be at most about any of the following values: 200, 195, 190, 185, 180, 175, 170, 165, 160, 155, 150, 145, 140, 135, 130, 125, 120, 115, 110, 105, 100, 95, 90, 85, 80, 75, 70, 65, 60, 55, 50, 45, 40, 35, 30, and 25 mils. Further, the average thickness of the foam may be at most about any of the following values: 4 inches, 3.5 inches, 3 inches, 2.5 inches, 2 inches, and 1.5 inches.

The density of the foam may be at least about any of the following: 0.5, 1, 3, 5, 8, 10, 12, 15, 20, 25, 30, and 35 pounds per cubic foot (lb/ft3). The density of the foam may be at most about any of the following values: 40, 35, 30, 25, 20, and 15 lb/ft3. The density may be measured according to ASTM D3575-00, Suffix W, Test Method A, which is incorporated herein in its entirety by reference.

The area density of the foam may be at least about any of the following: 5, 10, 15, 20, 25, 30, 35, 40, 45, 50, and 55 grams per square foot (gram/ft2). The area density of the foam may be at most about any of the following values: 300, 200, 100, 80, 75, 70, 65, 60, 55, 50, 45, 40, 35, 30, and 25 gram/ft2. The area density may be calculated by dividing the density of the foam by the average thickness of the foam.

The foam may have a surface resistivity of at least about (or between about) any of the following values: 1×10⁶, 1×10⁷, 1×10⁸, 1×10⁹, 5×10⁹, and 1×10¹⁰ ohms. Surface resistivity may be measured in accordance with ESD STM 11.11-2001, “Surface Resistance Measurement of Static Dissipative Planar Materials,” ESD Association, Rome, N.Y., which is incorporated in its entirety by reference, and ASTM D257-99 (the sample conditioned for 48 hours at 12% humidity (±3%) and 23° C. (±3° C.), with the test conducted at the same conditions, 100 volts test voltage, 1 minute time of electrification, with the shape and dimensions of the sample and electrodes appropriate for the sample material, in accordance with the testing standards and knowledge of those of skill in the art), which is also incorporated herein in its entirety by reference. The ESD testing standard shall control if any ambiguity or conflict between these two standards arises.

The foam preferably exhibits a flexural modulus sufficient to withstand the expected handling and use conditions. The flexural modulus of the foam may be at most about any of the following values: 4,000; 3,000; 2,500; 2,000; 1,900; 1,800; 1,700; 1,500; 1,200; 1,100; 1,000; 900; 800; 700; 600; and 500 psi. The flexural modulus of the foam may be at least about any of the following values: 800; 900; 1,000; 1,100; 1,200; 1,700; 1,800; 1,900; 2,000; 2,200; 2,500; and 3,000 psi (pounds/square inch). The flexural modulus (i.e., the tangent modulus of elasticity in bending) may be measured in accordance with ASTM D790-00 (Procedure A or B, depending on the nature of the foam, as set forth in the ASTM test), which is incorporated herein in its entirety by reference. If the foam is so flexible that it is difficult to run the above ASTM test procedure to calculate the flexural modulus (e.g., a foam with a flexural modulus of less than about 1,000 psi), then the ASTM test may be modified by using a higher “Z” (i.e., rate of straining) and/or stacking several samples of the foam together (taping the sample ends together) to run the test.

### Thermoplastic Polymer

The foam may comprise one or more thermoplastic polymers, such as polyolefins, polystyrenes, thermoplastic polyurethanes, polyamides, polyesters, polyvinyl chlorides, ionomers, and thermoplastic elastomers.

Useful polyolefins include ethylene homo- and co-polymers and propylene homo- and co-polymers. Polyolefins include polymers made by copolymerization of olefins with one or more other monomers where the olefins comprise at least 50 mass % of the resulting polymer. Ethylene homopolymers include high density polyethylene (“HDPE”) and low density polyethylene (“LDPE”). An exemplary LDPE has a melt flow index ranging from about 1 to about 40 and a density ranging from about 0.915 to about 0.930 g/cc.

Ethylene copolymers include ethylene/alpha-olefin copolymers (“EAOs”), ethylene/unsaturated ester copolymers, and ethylene/(meth)acrylic acid. (“Copolymer” as used in this application means a polymer derived from two or more types of monomers, and includes terpolymers, etc.)

EAOs are copolymers of ethylene and one or more alpha-olefins, the copolymer having ethylene as the majority mole-percentage content. The comonomer may include one or more of the following: C₃-C₂₀ α-olefins, one or more C₄-C₁₂ α-olefins, and one or more C₄-C₈ α-olefins. Exemplary α-olefins include 1-butene, 1-hexene, 1-octene, and mixtures thereof.

EAOs include one or more of the following: 1) medium density polyethylene (“MDPE”), for example having a density of from 0.93 to 0.94 g/cm3; 2) linear medium density polyethylene (“LMDPE”), for example having a density of from 0.926 to 0.94 g/cm3; 3) linear low density polyethylene (“LLDPE”), for example having a density of from 0.915 to 0.930 g/cm3; 4) very-low or ultra-low density polyethylene (“VLDPE” and “ULDPE”), for example having density below 0.915 g/cm3, and 5) homogeneous EAOs. Useful EAOs include those having a density of less than about any of the following: 0.925, 0.922, 0.92, 0.917, 0.915, 0.912, 0.91, 0.907, 0.905, 0.903, 0.9, and 0.898 grams/cubic centimeter. Unless otherwise indicated, all densities herein are measured according to ASTM D1505.

The polyethylene polymers may be either heterogeneous or homogeneous. As is known in the art, heterogeneous polymers have a relatively wide variation in molecular weight and composition distribution. Heterogeneous polymers may be prepared with, for example, conventional Ziegler Natta catalysts.

On the other hand, homogeneous polymers are typically prepared using metallocene or other single site-type catalysts. Such single-site catalysts typically have only one type of catalytic site, which is believed to be the basis for the homogeneity of the polymers resulting from the polymerization. Homogeneous polymers are structurally different from heterogeneous polymers in that homogeneous polymers exhibit a relatively even sequencing of comonomers within a chain, a mirroring of sequence distribution in all chains, and a similarity of length of all chains. As a result, homogeneous polymers have relatively narrow molecular weight and composition distributions. Examples of homogeneous polymers include the metallocene-catalyzed linear homogeneous ethylene/alpha-olefin copolymer resins available from the Exxon Chemical Company (Baytown, Tex.) under the EXACT trademark, linear homogeneous ethylene/alpha-olefin copolymer resins available from the Mitsui Petrochemical Corporation under the TAFMER trademark, and long-chain branched, metallocene-catalyzed homogeneous ethylene/alpha-olefin copolymer resins available from the Dow Chemical Company under the AFFINITY trademark.

Another useful ethylene copolymer is ethylene/unsaturated ester copolymer, which is the copolymer of ethylene and one or more unsaturated ester monomers. Useful unsaturated esters include: 1) vinyl esters of aliphatic carboxylic acids, where the esters have from 4 to 12 carbon atoms, and 2) alkyl esters of acrylic or methacrylic acid (collectively, “alkyl (meth)acrylate”), where the esters have from 4 to 12 carbon atoms.

Representative examples of the first (“vinyl ester”) group of monomers include vinyl acetate, vinyl propionate, vinyl hexanoate, and vinyl 2-ethylhexanoate. The vinyl ester monomer may have from 4 to 8 carbon atoms, from 4 to 6 carbon atoms, from 4 to 5 carbon atoms, and preferably 4 carbon atoms.

Representative examples of the second (“alkyl (meth)acrylate”) group of monomers include methyl acrylate, ethyl acrylate, isobutyl acrylate, n-butyl acrylate, hexyl acrylate, and 2-ethylhexyl acrylate, methyl methacrylate, ethyl methacrylate, isobutyl methacrylate, n-butyl methacrylate, hexyl methacrylate, and 2-ethylhexyl methacrylate. The alkyl (meth)acrylate monomer may have from 4 to 8 carbon atoms, from 4 to 6 carbon atoms, and preferably from 4 to 5 carbon atoms.

The unsaturated ester (i.e., vinyl ester or alkyl (meth)acrylate) comonomer content of the ethylene/unsaturated ester copolymer may range from about 6 to about 18 weight %, and from about 8 to about 12 weight %, based on the weight of the copolymer. Useful ethylene contents of the ethylene/unsaturated ester copolymer include the following amounts: at least about 82 weight %, at least about 85 weight %, at least about 88 weight %, at most about 94 weight %, at most about 93 weight %, and at most about 92 weight %, based on the weight of the copolymer.

Representative examples of ethylene/unsaturated ester copolymers include ethylene/methyl acrylate, ethylene/methyl methacrylate, ethylene/ethyl acrylate, ethylene/ethyl methacrylate, ethylene/butyl acrylate, ethylene/2-ethylhexyl methacrylate, and ethylene/vinyl acetate.

Another useful ethylene copolymer is ethylene/(meth)acrylic acid, which is the copolymer of ethylene and acrylic acid, methacrylic acid, or both.

Exemplary polypropylenes include atactic, isotactic, and/or syndiotactic polypropylene, long-chain branched polypropylene, and propylene/ethylene copolymers. The polypropylenes may have a melt flow index ranging from about 1 to 20 and a density ranging from about 0.87 to 0.915 g/cc. Useful propylene copolymer includes propylene/ethylene copolymers (“EPC”), which are copolymers of propylene and ethylene having a majority weight % content of propylene, such as those having an ethylene comonomer content of less than about any of the following: 10% and 6%; and may range from from about 2% to 6% by weight.

Exemplary polyamides include polyamide 6, polyamide 9, polyamide 10, polyamide 11, polyamide 12, polyamide 66, polyamide 610, polyamide 612, polyamide 61, polyamide 6T, polyamide 69, copolymers made from any of the monomers used to make two or more of the foregoing homopolymers (e.g., copolyamide 6/12, polyamide 12, copolyamide 66/69/61, copolyamide 66/610, copolyamide 6/66, and copolyamide 6/69), and blends of any of the foregoing homo- and/or copolymers. Polyamide copolymers include: (a) copolyamide 6/12 comprising (i) caprolactam mer in an amount of from about 20 to 80 weight percent (preferably 30 to 70 weight percent, more preferably 40 to 60 weight percent), and (ii) laurolactam mer in an amount of from about 80 to 20 weight percent; and (b) copolyamide 66/69/61 comprising 10 to 50 weight percent hexamethylene adipamide mer (preferably from about 20 to 40 weight percent), 10 to 50 weight percent polyamide 69 mer (preferably from about 20 to 40 weight percent), and 10 to 60 weight percent hexamethylene isophthalamide mer (preferably, from about 10 to 40 weight percent).

Exemplary polyesters include amorphous (co)polyesters, poly(ethylene/terephthalic acid), and poly(ethylene/naphthalate). Poly(ethylene/terephthalic acid) with at least about 75 mole percent, more preferably at least about 80 mole percent, of its mer units derived from terephthalic acid may be preferred.

A useful polystyrene is styrene/isoprene copolymer, for example one or more of the styrene/isoprene block copolymer thermoplastic elastomers available from Kuraray Co under the trademark Hybrar, such as Hybrar 5127. Also useful are high impact polystryrenes (i.e., polystryrene whose impact strength has been elevated by the incorporation of rubber particles).

Ionomer is a copolymer of ethylene and an ethylenically unsaturated monocarboxylic acid having the carboxylic acid groups partially neutralized by a metal ion, such as sodium or zinc, preferably zinc. Useful ionomers include those in which sufficient metal ion is present to neutralize from about 15% to about 60% of the acid groups in the ionomer. The carboxylic acid is preferably “(meth)acrylic acid”—which means acrylic acid and/or methacrylic acid. Useful ionomers include those having at least 50 weight % and preferably at least 80 weight % ethylene units. Useful ionomers also include those having from 1 to 20 weight percent acid units. Useful ionomers are available, for example, from Dupont Corporation (Wilmington, Del.) under the SURLYN trademark.

Useful thermoplastic elastomers include: 1) polyester thermoplastic elastomers (for example, those prepared by the polycondensation reaction of a poly(ether) diol with a mixture of a pthalate and a low molecular weight diol), 2) polyurethane elastomers, 3) polynorbomene rubber, 4) carboxylated rubber, 5) nitrile rubber, 6) poly(propylene oxide) elastomers, and 7) halogen containing elastomers.

The foam may comprise at least about any of the following amounts of thermoplastic polymer: 50, 55, 60, 65, 70, 75, 80, 85, 90, and 95% by weight of the foam. The previous weight percentages may also be applied to any one or more of the previously listed thermoplastic polymers. The foam may comprise a blend of one or more of any of the above thermoplastic polymers (e.g., a blend of polypropylene with polyethylene).

The thermoplastic polymer of the foam may have a melt flow index of at least about any of the following, or may range between about any of the following: 1, 2, 2.5, 3, 4, 5, 6, 7, 8, 9, 10, 15, 18, 20, 25, 30, 35, 40, 60, 80, and 100 grams/10 minutes. All references to melt-flow index in this application are measured according to ASTM D1238, at a temperature and piston weight as specified according to the material as set forth in the ASTM test method.

### Particles

The foam may include particles dispersed in the thermoplastic polymer of the foam. The foam may include at least about any of the following amounts of the particles (described below): 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, and 45 weight parts particles per hundred weight parts thermoplastic polymer in which the particles are dispersed. The foam may include at most about any of the following amounts of the particles (described below): 50, 49, 48, 47, 46, 45, 44, 43, 42, 41, 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8, and 7 weight parts particles per hundred weight parts thermoplastic polymer in which the particles are dispersed.

The particles may have an average size in the longest dimension of at least about any of the following: 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 220, 225, 230, 235, 240, 245, 250, 255, 260, 265, 270, 275, 280, 285, 290, 295 microns. The particles may have an average size in the longest dimension of at most about any of the following values: 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 220, 225, 230, 235, 240, 245, 250, 255, 260, 265, 270, 275, 280, 285, 290, 295 and 300 microns.

The particles may have either a theoretical density or an average bulk density (initial, before compaction) of at most about any of the following values: 3, 2.8, 2.6, 2.4, 2.2, 2, 1.8, 1.6, 1.5, 1.4, 1.3, 1.2, and 1 gram/cm3. The particles may have either a theoretical density or an average bulk density of at least about any of the following values: 0.5, 0.7, 0.9, 1, 1.2, 1.4, 1.8, and 2 gram/cm3. The bulk density of the particles may be measured according to ASTM D6683-01, which is incorporated herein in its entirety by reference. The theoretical density is that density which is the generally accepted value reported for the material making up the particle, for example, as reported in the CRC Handbook of Chemistry and Physics, 83th Edition.

The particles may have an average surface area of less than about any of the following values: 30, 25, 20, 18, 16, 14, 12, and 10 m2/gram. The particles may have an average surface area of at least about any of the following values: 2, 3, 4, 5, 6, 7, 8, 9, 10, 11, 12, 13, 14, and 15 m2/gram. The surface area/mass may be measured by nitrogen adsorption according to one or more of the following ASTM protocols appropriate for the material being tested: ASTM C1069-86, D1993-03, D5604-96, and D6556-02a; or other tests as generally recognized as appropriate for the sample material.

The particles dispersed in the thermoplastic polymer of the foam may be electrically conductive. An “electrically conductive“ particle as used herein means that the particle has a surface resistivity of less than 1×10⁶ ohms, measured according to ASTM D257-99 (25° C. and 50% relative humidity).

The particles dispersed in the thermoplastic polymer of the foam may be electrically non-conductive. “Electrically non-conductive” particles as used herein means that the particles are not “electrically conductive” as defined above.

The particles may comprise at least about any of the following amounts of inorganic material: 50, 60, 70, 80, 90, 95, 99, and 100% by weight of the particles. The particles may consist essentially of inorganic material. The particles may consist of inorganic material.

The particles may comprise at least about any of the following amounts of organic material: 50, 60, 70, 80, 90, 95, 99, and 100% by weight of the particles. The particles may consist essentially of organic material. The particles may consist of organic material.

Exemplary particle materials include: alumina, alumina trihydrate, aluminum, aluminum oxide, aluminum silicate, aluminum trihydroxide, antimony compounds (e.g., antimony oxide), apatite, ash, barium compounds (e.g., barium stearate, barium sulfate), bauxite, bentonite, beryllium oxide, boron nitride, brass, calcium compounds (e.g., calcium carbonate, calcium sulfate, calcium hydroxide, calcium silicate), carbon black, cement dust, ceramic beads, chalk, copper, diatomaceous earth, dolomite, feldspar, ferrous compounds, flyash, feldspar, glass (e.g., glass beads (hollow or solid), glass fibers, glass microballoons or microspheres), graphite, gypsum (e.g., calcined gypsum), iron, iron oxide, lead, lead oxide, lead silicate, limestone, magnesium compounds (e.g., magnesium carbonate, magnesium oxide, magnesium hydroxide), marble dust, metal, metallic compounds, nickel, nickel compounds, organic fillers (e.g., nut shells, rice hulls, cornmeal, wood flour), polymer microballoons, pumice, pyrophyllite, rubber particles, sepiolite, silica (e.g., fumed silica), silica-based materials, silicates (e.g., layered silicates, phyllosilicates, such as clay, as discussed below), silver power, talc, titanium dioxide, titanates, wollastonite, zeolites, zinc, zinc compounds (e.g., zinc oxide), fiberous materials from carbon and cellulose.

Exemplary particle materials also include clay, such as smectite clay, for example, bentonite clay (e.g., montmorillonite, hectorite, laponite), mica, vermiculite, bentonite, nontronite, beidellite, volkonskoite, kaolin, kaolinite, and saponite; and layered polysilicate (e.g., layered silicic acid), such as kanemite, makatite, ilerite, octosilicate, magadiite, and kenyaite. The clay may be a nanoclay.

The particles may comprise at least about any of the following amounts of one or more of the above exemplary materials: 50, 60, 70, 80, 90, 95, 99, and 100% by weight of the particles. The particles may consist essentially of one or more of the above exemplary materials. The particles may consist of one or more of the above exemplary materials.

An exemplary particle comprising vermiculite material is available from W.R. Grace & Co. (Grace Building Products) under the FPSV trademark.

An exemplary glass microbubble is available from Minnesota Mining and Manufacturing Company under the SCOTCHLITE K46 trademark (density of about 0.46 g/cc). Exemplary polymer microballoons include those available from Sovereign Specialty Chemicals under the trademark Micropearls and those available from Akzo-Nobel under the Expancel trademark.

### Manufacture of the Foam

The foam may be made by an extrusion process. The thermoplastic polymer (e.g., in pellet form) may be added to an extruder. The thermoplastic polymer may already incorporate the dispersed particles and/or additional additives (discussed below) at the time the polymer is added to the extruder, or alternatively, the particles and/or additional additives may be added to the extruder at a time separately from the addition of the polymer. The extruder heats the thermoplastic polymer above its glass transition temperature or melting point and mixes the thermoplastic polymer, together with the particles. The extruder may be, for example, a single screw, double screw, and/or tandem extruder.

A blowing agent is mixed with the melted polymer, for example by adding the blowing agent to the melted polymer via one or more injection ports in the extruder. The blowing agent is at least partially miscible with the polymer at the temperature and pressure conditions within the extruder such that at least a portion of the blowing agent dissolves into the molten polymer.

The extruder pushes the melt mixture (melted polymer, particles, blowing agent, and optional additives) through a die at the end of the extruder and into a region of reduced temperature and pressure (relative to the temperature and pressure within the extruder). Typically, the region of reduced temperature and pressure is the ambient atmosphere. The sudden reduction in pressure causes that portion of the blowing agent that is dissolved in the polymer to come out of solution, nucleate, and vaporize/expand into a plurality of cells within the polymer that solidify upon cooling of the polymer mass (due to the reduction in temperature), thereby trapping the blowing agent within the cells and forming the foam.

The blowing agent may be selected such that the rate of diffusion of the blowing agent out of the foam is slow enough to approximate the rate of diffusion of air into the foam to reduce the likelihood of significant cell wall collapse.

Exemplary inorganic blowing agents include carbon dioxide, nitrogen, argon, water, air, sulfur hexafluoride (SF(6)) and helium.

Exemplary organic blowing agents include aliphatic hydrocarbons having 1-9 carbon atoms, aliphatic alcohols having 1-3 carbon atoms, and fully and partially halogenated aliphatic hydrocarbons having 1-4 carbon atoms. Aliphatic hydrocarbons include methane, ethane, propane, n-butane, isobutane, n-pentane, isopentane, neopentane, and the like. Aliphatic alcohols include methanol, ethanol, n-propanol, and isopropanol. Fully and partially halogenated aliphatic hydrocarbons include fluorocarbons, chlorocarbons, and chlorofluorocarbons. Examples of fluorocarbon blowing agents include methyl fluoride, perfluoromethane, ethyl fluoride, 1,1-difluoroethane (HFC-152a), fluoroethane (HFC-161), 1,1,1 - trifluoroethane (HFC-143a), 1,1,1,2-tetrafluoroethane (HFC-134a), 1,1,2,2-tetrafluoroethane (HFC-134), 1,1,1,3,3-pentafluoropropane, pentafluoroethane (HFC-125), difluoromethane (HFC-32), perfluoroethane, 2,2-difluoropropane, 1,1,1-trifluoropropane, perfluoropropane, dichloropropane, difluoropropane, perfluorobutane, and perfluorocyclobutane. Partially halogenated chlorocarbon and chlorofluorocarbon blowing agents include methyl chloride, methylene chloride, ethyl chloride, 1,1,1-trichloroethane, 1,1-dichloro-1 fluoroethane (HCFC-141b), 1-chloro-1,1-difluoroethane (HCFC-142b), chlorodifluoromethane (HCFC-22), 1,1-dichloro-2,2,2-trifluoroethane (HCFC-123) and 1-chloro-1,2,2,2-tetrafluoroethane (HCFC-124). Fully halogenated chlorofluorocarbons include trichloromonofluoromethane (CFC-11), dichlorodifluoromethane (CFC-12), trichlorotrifluoroethane (CFC-113), 1,2-dichlorotetrafluoroethane (CFC-114), chloroheptafluoropropane, and dichlorohexafluoropropane.

Exemplary chemical blowing agents include azodicarbonamide, azodiisobutyro-nitrile, barium azodicarboxylate, N,N′-dimethyl-N,N′-dinitrosoterephthalamide, and benzenesulfonhydrazide, 4,4-oxybenzene sulfonyl semicarbazide, and p-toluene sulfonyl semicarbazide, trihydrazino triazine and mixtures of citric acid and sodium bicarbonate, such as the various products available from Clariant Additives under the trademark Hydrocerol.

The foregoing blowing agents may be used alone or in combination with one or more other blowing agents. For example, U.S. Pat. Nos. 4,694,027; 4,640,933; and 4,663,361, each of which is incorporated herein in its entirety by reference, teach as a blowing agent a mixture of at least 70% isobutane with a physical blowing agent selected from the group consisting of hydrocarbons, chlorocarbons, and chlorofluorocarbons having from 1 to 5 carbon atoms, boiling points between −50° C. and 50° C., and a permeation rate through an olefin polymer resin modified with a stability control agent of greater than about 1.2 times the permeation rate of air. U.S. Pat. No. 6,323,245 issued Nov. 27, 2001, which is incorporated herein in its entirety by reference, teaches a blowing agent comprising a blend of from 35 to 65 weight % isobutane and from 35 to 65 weight % n-butane.

A sufficient amount of blowing agent may be incorporated into the thermoplastic polymer to make a foam having the desired foam characteristics for the selected processing and material conditions. For example, the amounts of blowing agent added to the thermoplastic polymer may be within any of the following ranges: from about 0.05 to about 5, from about 0.2 to about 3, and from about 0.5 to 2.5 gram moles blowing agent per kilogram of thermoplastic polymer.

The foam may be perforated to enhance or accelerate gaseous permeation exchange (i.e., blowing agent exiting from the foam and air entering into the foam). The perforation channels may extend from one foam surface partially through the foam, or may extend completely through the foam from one external surface to the other external surface. Such perforation channels may advantageously be present over substantially an entire exterior foam surface.

The foam may be unapertured; that is, the foam may be devoid of apertures passing completely through the foam.

Effective amounts of various additional additives known to those of skill in the art may be added to the thermoplastic polymer in making the foam, if desired. These additional additives include nucleating agent, aging modifier (e.g., a fatty acid ester, a fatty acid amide, a hydroxyl amide), pigment, colorant, antioxidant, flame retardant, stabilizer, fragrance, and odor masking agent. The nucleating agent may assist in controlling the size of foam cells. The stabilizer may enhance dimensional stability of the foam. Exemplary stabilizers include amides and esters of C(10-24)fatty acids, stearyl stearamide, glyceromonostearate, glycerol monobehenate, and sorbitol monostearate.

The thermoplastic polymer of the foam may be crosslinked to modify the performance characteristics to a desired level, or may be non-crosslinked. For the purposes of this application, the term “thermoplastic polymer” includes polymer that originally displayed thermoplastic characteristics during processing, but because of subsequent crosslinking may no longer be capable of repeated softening and hardening by heating and cooling (e.g., melted by reheating).

Crosslinking of thermoplastic polymer may be achieved, for example, by chemical crosslinking or by radiation induced crosslinking.

Chemical crosslinking may be achieved by incorporating one or more crosslinking agents (e.g., organic peroxides, such as dicumyl peroxide) with the thermoplastic polymer and exposing the combination to an activating condition, such as an effective amount of heat, pressure, or irradiation, or a combination thereof. Chemical crosslinking may or may not require irradiation for activation.

Radiation induced crosslinking occurs by irradiating the polymer of the foam with one or more energetic radiation treatments (e.g., electron beam, X-ray, gamma ray, beta ray) to induce cross-linking between molecules of the irradiated material without the use of a crosslinking agent to facilitate the crosslinking. Useful radiation dosages may include at least about any of the following: 5, 7, 10, 15, 20, 25, 30, 35, 40, 45, and 50 kGy (kiloGrey). Useful radiation dosages may include less than about any of the following: 150, 130, 120, 110, 100, 90, 80, 75, and 70 kGy (kiloGrey).

The degree of crosslinking that exists in the crosslinked thermoplastic polymer of the foam may be characterized by conducting a “gel content test.” The gel content test selects a solvent and conditions that would solubilize the non-crosslinked portion but which is unable to solubilize the crosslinked portion (i.e., “gel”) of the thermoplastic resin once it has been crosslinked. The result is expressed as a “percent gel,” which is the amount of insoluble (i.e., crosslinked) component over the total weight of the thermoplastic polymer that has been exposed to the crosslinking conditions.

The percent gel content of the crosslinked thermoplastic polymer of the foam may be 0% (i.e., undetectable) or may be at least about, or less than about, any of the following values: 5, 10, 15, 20, 25, 30, 35, 40, 45, 50, 60, 70, 80, 90, and 100%; and may range between any two of the values in this paragraph. The gel content may be measured according to ASTM D 2765-95, which is incorporated herein in its entirety by reference.

### Use of the Foam

The foam may be useful for sound dampening, acoustical insulation, and/or acoustical absorption applications. The foam may be formed, molded, or cut to various shapes to incorporate or attach the foam into, onto, or to one or more of the following articles:
transportation vehicles, such as automobiles, motorcycles, buses, tractors, trains, trams, airplanes, jets, watercraft (e.g., boats, jet skis), submarines,
automotive components, such as door liners, truck liners, rear seat strainers, wheel well covers, headliners, enclosures such as oil pans, molded dash insulators, dash mats, mufflers, disc brake pads (e.g., non-squeal),
carpet and flooring underlayments, molded or moldable carpet assemblies (e.g., with sound deadening backing),
wallpaper and wall coverings,
small and large appliances (household and other), such as dishwashers, refrigerators, air conditioners, blender housings, vacuum cleaning machines, power tools, leaf blowers, snow blowers,
small engines (e.g., outboard motors, lawnmower engines)
loudspeakers, headphones, and hearing protection devices,
disc drive systems,
acoustical mat compositions,
marine components,
building panels, walls, ceilings, roofs, and partitions, and
thermal and/or sound insulation materials (including composites thereof) for buildings and other structures.

The foam may be incorporated or attached into, onto, or to an article by any of lamination, adhesion, or other form of attachment, or combination thereof (e.g., via staple, tack, screw, nail, bolt, tape, hanging, adhesive, melt bonding, clamping, binding). For examle, the foam may be incorporated or attached to a component or member of the article (such as a metal, wood, or plastic member or component of the article). By incorporating or attaching the foam, the sound attenuation of the article may be enhanced (i.e., the sound transmission loss of the article with the foam is improved relative to the sound transmission loss of the article without the foam).

The following examples are presented for the purpose of further illustrating and explaining the present invention and are not to be taken as limiting in any regard. Unless otherwise indicated, all parts and percentages are by weight.

### EXAMPLE 1

A single-layer, closed cell foam was formed by blending a) 90 weight % low density polyethylene (LDPE) having a density of 0.919 g/cc and a melt flow index of 2 g/10 minutes with b) 10 weight % Hydrocerol CF-20E (Clariant Additives) blowing agent masterbatch. The resulting blend was fed with a K-Tran Gravimetric feeder into a Leistritz 18 mm corotating twin screw extruder at 25 grams per minute. Additionally, 8 weight parts of FPSV vermiculite (Grace Building Products) particles per 100 weight parts LDPE were fed into the throat of the extruder with a calibrated volumetric feeder. The extruder temperatures from the throat to the extrusion head were as follows: 112° C./135° C./180° C./200° C./200° C./135° C./130° C./130° C. The screw speed was 100 rpm. The die pressure was 560 psi. The extrudate foamed as it came out of the die, due to the pressure drop. It is believed that the Hydrocerol chemical blowing agent released gas for expanding the foam while also leaving tiny residues as nucleation site to assist in forming cells. Immediately after extrusion, the resulting fine-celled foam was quenched on a chill roll set at 37° C. The resulting foam had a thickness of 45 mils, a width of 6 inches, and an area density of 38 g/ft².

### EXAMPLE 2

A single-layer, closed cell foamed was formed having the same components and processing conditions as set forth for Example 1, except that 24 weight parts of aluminum particles (AL-101 powder, Micron Metals, Inc.) per 100 parts LDPE were fed to the mixture rather than the mica particles. The resulting foam had a thickness of 57 mils, a width of 6 inches, and an area density of 59 g/ft².

### EXAMPLE 3

A single-layer, closed cell foam was formed having the same components and processing conditions as set forth for Example 1, except that 13.5 weight parts glass microballoons (Available from 3M Corp. under the K46 tradename) per 100 parts LDPE were fed to the mixture rather than the mica particles. The resulting foam had a thickness of 61 mils, a width of 6 inches, and an area density of 56 g/ft².

### COMPARATIVE SAMPLE 1

A single-layer, closed cell foam was formed having the same components and processing conditions as set forth for Example 1, except that the mica particles were omitted. The resulting foam had a thickness of 70 mils, a width of 6 inches, and an area density of 61 g/ft².

### Sound Transmission Loss Measurement

The sound transmission loss was measured for the Examples and Comparative Sample using the following insertion loss technique to measure the loss of airborne sound. A sound booth with a noise barrier wall separated two chambers in the booth. The wall had an aperture to allow sound to pass from one chamber into the next chamber to measure the sound transmission from one booth to the other booth. The sound transmission was measured first without a test sample, and then with a 1.5″×1.5″ test sample covering the aperture. The sound level (dB) and frequency (Hz) that passed through the aperture were measured. The two sound levels were subtracted from each other for each frequency level measured. The resulting difference (i.e., A dB) was recorded as the sound level attenuation. The results are shown in Table 1.

TABLE 1

| | Area density | STL at 40 Hz | STL at 100 Hz | STL at 400 Hz | STL at 1000 Hz |
|---|---|---|---|---|---|
| | (g/ft²) | (Δ dB) | (Δ dB) | (Δ dB) | (Δ dB) |
| Example 1 | 38 | 26 | 28 | 27 | 29 |
| (8 pph mica) | | | | | |
| Example 2 | 59 | 25 | 29 | 28 | 29 |
| (24 pph AL) | | | | | |
| Example 3 | 56 | 25 | 28 | 26 | 26 |
| (13.5 pph glass) | | | | | |
| Comparative 1 | 61 | 27 | 28 | 27 | 29 |
| (0 pph particles) | | | | | |

The above descriptions are those of preferred embodiments of the invention. Various alterations and changes can be made without departing from the spirit and broader aspects of the invention as defined in the claims, which are to be interpreted in accordance with the principles of patent law, including the doctrine of equivalents. Except in the claims and the specific examples, or where otherwise expressly indicated, all numerical quantities in this description indicating amounts of material, reaction conditions, use conditions, molecular weights, and/or number of carbon atoms, and the like, are to be understood as modified by the word “about” in describing the broadest scope of the invention. Any reference to an item in the disclosure or to an element in the claim in the singular using the articles “a,” “an,” “the,” or “said” is not to be construed as limiting the item or element to the singular unless expressly so stated. All references to ASTM tests are to the most recent, currently approved, and published version of the ASTM test identified, as of the priority filing date of this application. Each such published ASTM test method is incorporated herein in its entirety by this reference.

1. A foam comprising:
at least about 50 weight percent thermoplastic polymer; and
from about 5 to about 50 weight parts of particles dispersed in the thermoplastic polymer per 100 weight parts of the thermoplastic polymer, wherein:
the particles have an average size in the longest dimension of from about 5 to about 300 microns;
the foam is closed-cell; and
provided that if the particles are electrically conductive, then the foam has a surface resistivity of at least about 1×10⁶ohms.

2. The foam of claim 1 wherein the particles comprise at least about 50% inorganic material by weight of the particles.

3. The foam of claim 1 wherein the particles comprise at least about 90% inorganic material by weight of the particles.

4. The foam of claim 1 wherein the particles comprise at least about 50% organic material by weight of the particles.

5. The foam of claim 1 wherein the particles comprise one or more clays selected from mica and vermiculite.

6. The foam of claim 1 wherein the particles comprise aluminum.

7. The foam of claim 1 wherein the particles comprise glass.

8. The foam of claim 1 comprising at most about 40 weight parts of the particles dispersed in the thermoplastic polymer per 100 weight parts of the thermoplastic polymer.

9. The foam of claim 1 comprising at most about 30 weight parts of the particles dispersed in the thermoplastic polymer per 100 weight parts of the thermoplastic polymer.

10. The foam of claim 1 comprising at most about 20 weight parts of the particles dispersed in the thermoplastic polymer per 100 weight parts of the thermoplastic polymer.

11. The foam of claim 1 comprising at least about 20 weight parts of the particles dispersed in the thermoplastic polymer per 100 weight parts of the thermoplastic polymer.

12. The foam of claim 1 wherein the particles have an average size in the longest dimension of at least about 10 microns.

13. The foam of claim 1 wherein the particles have an average size in the longest dimension of at least about 30 microns.

14. The foam of claim 1 wherein the particles are electrically non-conductive.

15. The foam of claim 1 wherein the foam has no more than about 10% open cell volume.

16. The foam of claim 1 comprising a sheet configuration with an average thickness of from about 1 mil to about 4 inches.

17. The foam of claim 1 comprising a sheet configuration with an average thickness of from about 1 mil to about 200 mils.

18. The foam of claim 1 comprising a sheet configuration with an average thickness of from about 0.2 inches to about 4 inches.

19. The foam of claim 1 comprising a sheet configuration with an average thickness of from about 1 mil to about 4 inches.

20. The foam of claim 1 wherein the foam has a density of from about 5 to about 40 pounds/ft3.

21. The foam of claim 1 wherein the foam has an area density of from about 10 to about 100 g/ft2.

22. The foam of claim 1 wherein the foam has a flexural modulus of at most about 1,000 pounds/square inch.

23. The foam of claim 1 wherein the foam has a flexural modulus of from about 1,100 to about 1,800 pounds/square inch.

24. The foam of claim 1 wherein the foam has a flexural modulus of at least about 1,900 pounds/square inch.

25. The foam of claim 1 wherein the foam is unapertured.

26. The foam of claim 1 wherein the foam comprises at least about 50 weight percent of one or more polyolefins.

27. The foam of claim 1 wherein the foam comprises at least about 50 weight percent of one or more polyethylene homopolymers.

28. The foam of claim 1 wherein the thermoplastic polymer comprises one or more polymers selected from polypropylene homopolymers, polypropylene copolymers, polyethylene homopolymers, polyethylene copolymers, ethylene/vinyl acetate copolymer, polystryrene homopolymer, polystyrene copolymer, and high impact polystyrene.

29. The foam of claim 1 wherein the particles have an average size in the longest dimension of at most about 100 microns.

30. The foam of claim 1 wherein the density of the foam is from about 0.5 to about 40 pounds/ft3.

31. The foam of claim 1 wherein the density of the foam is from about 10 to about 30 pounds/ft3.

32. A method of enhancing the sound attenuation of an article comprising attaching the foam of claim 1 to the article.

33. A method of enhancing the sound attenuation of an article comprising incorporating the foam of claim 1 into the article.
